(19) United States
(12) Patent Application Publication
(10) Pub. No.: US 2014/0146260 A1
(43) Pub. Date: May 29, 2014

(54) DISPLAY DEVICE

(71) Applicant: Samsung Display Co., Ltd., Yongin-City (KR)

(72) Inventor: Seung Jae LEE, Seoul (KR)

(21) Appl. No.: 13/943,915

(22) Filed: Jul. 17, 2013

(30) Foreign Application Priority Data
Nov. 28, 2012 (KR) 10-2012-0136268

(51) Int. Cl. G02F 1/1345; G02F 1/1333

(52) U.S. Cl. CPC G02F 1/13458; G02F 1/133345
USPC 349/43; 349/142

(57) ABSTRACT

A display device having a first substrate including a display area and a fanout area. A number of pixels are formed in the display area. A number of signal lines connected to the pixels in the display area form a number of wiring portions in the fanout area and a number of dummy patterns formed in a dummy area between the wiring portions.

### CLAIM PRIORITY

This application makes reference to, incorporates the same herein, and claims all benefits accruing under 35 U.S.C. §119 from an application earlier filed in the Korean Intellectual Property Office on 28 Nov. 2012 and there duly assigned Serial No 10-2012-0136268.

### BACKGROUND OF THE INVENTION

1. Field of the Invention

Aspects of the present invention generally relate to a display device.

2. Description of the Related Art

With the development of display technology, display devices are being widely used in portable devices (such as notebook computers, mobile phones and portable media players (PMPs)) as well as display devices for homes (such as TVs and monitors). In particular, the trend toward lighter and thinner display devices is increasing the popularity of liquid crystal displays (LCDs), organic electroluminescent displays, etc.

The above information disclosed in this Related Art section is only for enhancement of understanding of the background of the invention and therefore it may contain information that does not form the prior art that is already known to a person of ordinary skill in the art.

### SUMMARY OF THE INVENTION

Aspects of the present invention provide a display device which can prevent stain defects due to an organic layer.

Aspects of the present invention also provide a display device which can display a uniform image by minimizing stain defects.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there may be provided a display device including: a first substrate including a display area and a fanout area; a plurality of pixels formed in the display area; a plurality of signal lines connected to the pixels in the display area and forming a plurality of wiring portions in the fanout area; and a plurality of dummy patterns formed in a dummy area between the wiring portions.

According to another aspect of the present invention, there may be provided a display device including: a display area in which a plurality of signal lines intersect each other; a pad area in which a plurality of pads delivering signals received from an external source to the signal lines and connected to the signal lines are disposed; a fanout area which may be formed between the pad area and the display area and in which a plurality of wiring portions connecting the pads and the signal lines are formed; and a plurality of dummy patterns which are formed in a dummy area between the wiring portions.

According to another aspect of the present invention, there may be provided a display device including: a first substrate; a second substrate facing the first substrate; and a liquid crystal layer interposed between the first substrate and the second substrate, wherein the first substrate includes: a display area in which a plurality of signal lines intersect each other; a pad area in which a plurality of pads delivering signals received from an external source to the signal lines and connected to the signal lines are disposed; a fanout area which may be formed between the pad area and the display area and in which a plurality of wiring portions connecting the pads and the signal lines are formed; and a plurality of dummy patterns which are formed in a dummy area between the wiring portions.

Embodiments of the present invention provide at least the following advantageous effects.

According to the present invention, the organic layer can be formed to a uniform height, minimizing stain defects in an image.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a layout view of a display device according to an embodiment of the present invention;

FIG. 2 is an enlarged view of a portion of the display device shown in FIG. 1;

FIG. 3 is an enlarged view of a portion of the display device shown in FIG. 2;

FIG. 4 is a cross-sectional view of the display device of FIG. 2, taken along the line I1-I2;

FIG. 5 is an enlarged view of another portion of the display device shown in FIG. 1;

FIG. 6 is an enlarged view of a portion B of the display device shown in FIG. 5;

FIG. 7 is a cross-sectional view of the display device 1 of FIG. 5, taken along the line I3-I4;

FIG. 8 is a cross-sectional view of a modified embodiment of the display device of FIG. 2, taken along the line I1-I2; and

FIG. 9 is a cross-sectional view of a modified embodiment of the display device of FIG. 5, taken along the line I3-I4.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification. In the drawings, the size or relative size of the layers and regions are exaggerated for clarity.

It will be understood that when an element or layer is referred to as being “on” another element or layer, it can be directly on the other element or layer or intervening elements or layers may be present.

It will be understood that, although the terms first, second, third, etc., may be used herein to describe various components, these components should not be limited by these terms. These terms are only used to distinguish one component from another component. Thus, a first component discussed below could be termed a second component without departing from the teachings of the present invention.

Embodiments of the present invention will now be described with reference to the accompanying drawings.

A case where a display device according to the present invention is applied to a liquid crystal display (LCD) will be described below. However, this is merely an example, and the present invention is applicable to all display devices (such as an organic light-emitting display (OLED) and a white OLED (WOLED)) which have been developed and commercialized or are realizable depending on future technological developments.

LCDs are one of the most widely used types of display devices. Generally, an LCD includes two substrates and a liquid crystal layer interposed between the two substrates. In the LCD, voltages are applied to electrodes formed on at least one of the two substrates to generate an electric field. Accordingly, liquid crystal molecules of the liquid crystal layer are rearranged, thereby controlling the amount of light that passes through the liquid crystal layer.

LCDs can be classified into transmissive LCDs, reflective LCDs, and semi-transmissive LCDs. In the transmissive LCDs, light emitted from a backlight may be incident on liquid crystals from behind the liquid crystals. The transmissive LCDs display an image by controlling the transmittance of the incident light. The reflective LCDs display an image by reflecting external light incident on liquid crystals using a reflective plate of a substrate. The semi-transmissive LCDs are a combination of the transmissive LCDs and the reflective LCDs.

In a reflective or semi-transmissive LCD, an organic layer having protrusions and recesses may be formed under a reflective plate, so that the protrusions and recesses of the organic layer can be reflected in the reflective plate. Accordingly, the reflective plate can scatter light incident from an external source. As a result, a uniform image can be obtained.

Generally, an organic layer may be formed by spin coating. However, if a step exists under the organic layer, the organic layer may be formed to have a non-uniform thickness. In this case, even if the organic layer may be patterned to have protrusions and recesses, the profile of the protrusions and recesses may not be uniform, resulting in stains in an image.

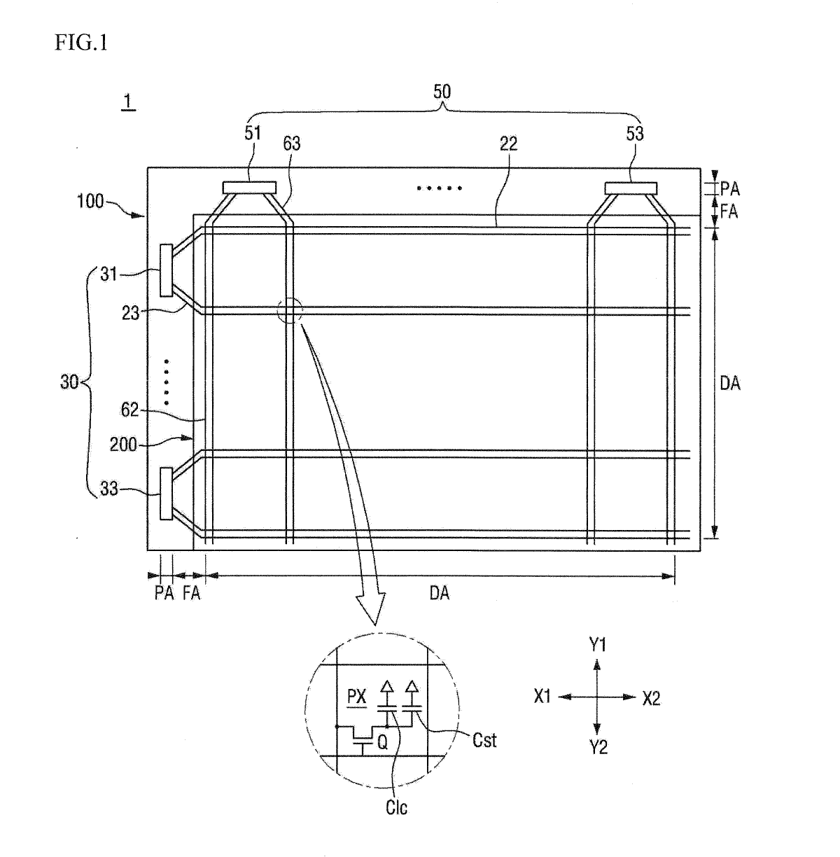

FIG. 1 is a layout view of a display device 1 according to an embodiment of the present invention.

Referring to FIG. 1, the display device 1 according to the present invention may include a first substrate 100, a second substrate 200 which faces the first substrate 100, and a liquid crystal layer (not shown) which may be formed by injecting liquid crystals into a space between the first substrate 100 and the second substrate 200. The display device 1 may further include a sealing layer (not shown) which fixes the first substrate 100 and the second substrate 200 in position and traps the liquid crystals. A polarizer may further be disposed on the outside of the first substrate 100 and the second substrate 200.

The second substrate 200 may include a black matrix (not shown) which has openings separated from each other by a predetermined gap and red, green and blue color filters (not shown) which are arranged sequentially in corresponding pixel regions, respectively. The second substrate 200 may further include a common electrode (not shown) on a surface which faces the first substrate 100. The common electrode may be made of a transparent conductor, such as indium tin oxide (ITO) or indium zinc oxide (IZO), or metal.

The first substrate 100 may include a display area DA which displays an image signal and a non-display area excluding the display area DA. The non-display area may include a fanout area FA and a pad PA.

In the pad area PA, signal lines 22 and 62 may be connected to drivers such as a gate driver 30 and a data driver 50. More specifically, an end of each gate line 22 may be electrically connected to the gate driver 30 by a gate pad (not shown), and an end of each data line 62 may be electrically connected to the data driver 50 by a data pad (not shown). The drivers 30 and 50 supply gate signals, data signals, control signals, a common voltage Vcom, power, etc. for driving the LCD. The gate driver 30 may include a plurality of gate driver integrated circuits (ICs) 31 and 33, and the data driver 50 may include a plurality of data driver ICs 51 and 53. In FIG. 1, two gate driver ICs 31 and 33 and two data driver ICs 51 and 53 are provided. However, this is merely an example, and the number of gate or data driver ICs can be varied as desired.

The drivers 30 and 50 can have any form. For example, the drivers 30 and 50 can be mounted directly on the pad area PA of the first substrate 100 in the form of at least one IC chip. Alternatively, the drivers 30 and 50 can be mounted on a flexible printed circuit board (FPCB) and then attached to the pad area PA in the form of a tape carrier package (TCP). Otherwise, the drivers 30 and 50 can be mounted on a printed circuit board (PCB) attached to the pad area PA. Further, the drivers 30 and 50 can be integrated together with the signal lines 22 and 62 and a switching element Q.

The pad area PA can be defined as an area of the first substrate 100 which is not hidden by the second substrate 200. In this case, the second substrate 200 may be formed to have a smaller area than the first substrate 100.

The display area DA may be where an image is displayed. In the display area DA, a plurality of pixels PX are arranged in a matrix.

Each of the pixels PX may include the switching element Q implemented as a thin-film transistor (TFT), a liquid crystal capacitor Clc, and a storage capacitor Cst. The storage capacitor Cst may be optional.

The switching element Q may be formed on the first substrate 100 and may be a three-terminal element. A control terminal and an input terminal of the switching element Q may be connected to a gate line 22 and a data line 62, respectively, and an output terminal of the switching element Q may be connected to the liquid crystal capacitor Clc and the storage capacitor Cst. The gate line 22 may deliver a gate signal which turns the switching element Q on or off, and the data lines 62 may deliver a data signal which corresponds to an image signal.

The liquid crystal capacitor Clc may use a pixel electrode (not shown) of the first substrate 100 and the common electrode (not shown) of the second substrate 200 as its two terminals, and the liquid crystal layer between the pixel electrode and the common electrode may function as a dielectric. The pixel electrode may be connected to the switching element Q, and the common electrode may be formed on the whole surface of the second substrate 200 and may be provided with the common voltage Vcom.

The storage capacitor Cst may be formed by a signal line (not shown) and the pixel electrode which overlaps the signal line formed on the first substrate 100, and a predetermined voltage such as the common voltage Vcom may be applied to the signal line. Alternatively, the storage capacitor Cst may be formed by the pixel electrode, a gate line 22 which may be located directly above the pixel electrode and overlaps the pixel electrode, and an insulator therebetween.

The signal lines 22 and 62 located in the display area DA may include the gate lines 22 which extend in an X1-X2 direction and the data lines 62 which extend in a Y1-Y2 direction. The gate lines 22 may intersect the data lines 62 to define pixel regions, and a gap between lines may have a width determined by the size of a pixel PX. That is, a gap between the signal lines 22 or 62 may be greater in the display area DA than in the pad area PA. Therefore, an area in which the gap between the signal lines 22 or 62 gradually increases may exist between the pad area PA and the display area DA. This area between the pad area PA and the display area DA is referred to as the fanout area FA.

In the fanout area FA, the signal lines 22 and 62 connected to a plurality of driver ICs may form wiring portions 23 and 63 which are, overall, trapezoidal. An area of the fanout area FA excluding the wiring portions 23 and 63 will hereinafter be referred to as a dummy area DU.

While a case where the black matrix, the color filters, and the common electrode are formed in the second substrate 200 has been described above, this is merely an example. Optionally, the black matrix, the color filters, and the common electrode can be formed on the first substrate 100.

When an organic layer may be formed by spin-coating an organic insulating material in a manufacturing process, the organic material can be concentrated in a certain area, thus causing stain defects. To prevent this problem, the display device 1 according to the present invention may further include dummy patterns formed in the dummy area DU which may be an area of the fanout area FA excluding the wiring portions 23 and 63.

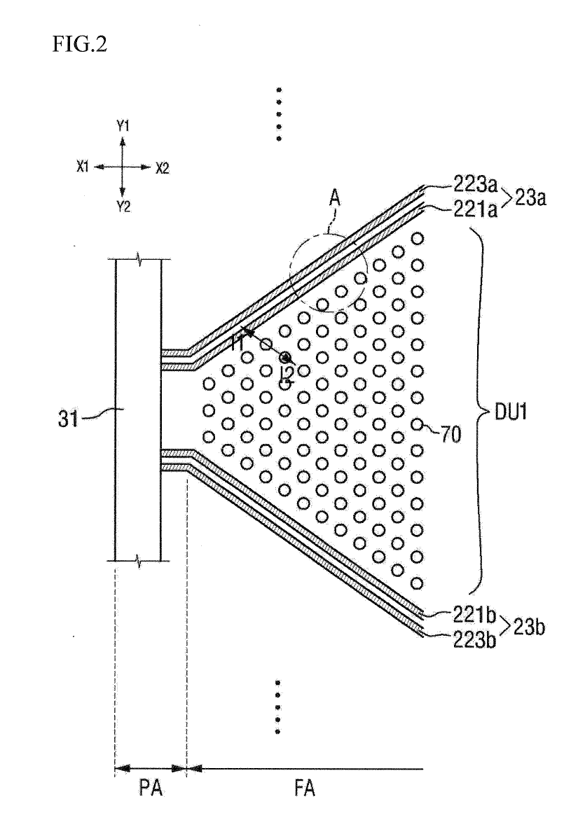

FIG. 2 is an enlarged view of a portion of the display device 1 shown in FIG. 1. More specifically, FIG. 2 is an enlarged view of the fanout area FA formed on the side of the gate driver 30.

Referring to FIGS. 1 and 2, a plurality of gate lines 221a, 223a, 221b and 223b may be electrically connected to the gate driver IC 31 in the pad area PA by gate pads (not shown). The gate lines 221a, 223a, 221b and 223b may form wiring portions 23a and 23b which are, overall, trapezoidal.

The wiring portions 23a and 23b may include the first wiring portion 23a which has a positive slope with respect to an X1-X2 axis and consists of the gate lines 221a and 223a extending in an X2-Y1 direction and the second wiring portion 23b which has a negative slope with respect to the X1-X2 axis and consists of the gate lines 221b and 223b extending in an X2-Y2 direction. A dummy area DU1 may be formed between the first wiring portion 23a and the second wiring portion 23b.

A plurality of dummy patterns 70 may be formed in the dummy area DU1. The dummy patterns 70 may be separated from each other. An area of the fanout area FA in which the wiring portions 23a and 23b are not formed may be lower than the wiring portions 23a and 23b in which the gate lines 221a, 223a, 221b and 223b are concentrated. Therefore, when an organic layer may be formed by coating an organic material, the organic material may be coated unevenly due to the structure of the wiring portions 23a and 23b themselves or a step difference between the wiring portions 23a and 23b and their surrounding area. Accordingly, the organic layer may be formed to have a non-uniform thickness, resulting in linear stains in an image. In the current embodiment, the dummy patterns 70 may be formed in the dummy area DU1 to compensate for the step difference between the wiring portions 23a and 23b and their surrounding area. When an organic layer may be formed, the dummy patterns 70 prevent an organic material from being concentrated in a certain area due to the step difference. Thus, the organic layer can be formed to a uniform height, minimizing stain defects in an image.

The dummy patterns 70 can have any planar shape. In FIG. 2, the planar shape of the dummy patterns 70 may be a circular shape. However, this is merely an example, and the dummy patterns 70 can have various planar shapes. For example, the planar shape of the dummy patterns 70 may be any one of a polygonal shape (such as a triangle, a quadrangle, a pentagon or a hexagon) and an oval shape or a combination of these shapes. In particular, if the dummy patterns 70 have a planar shape without corners, such as a circular shape or an oval shape, the effect of static electricity can additionally be minimized.

To compensate for a step difference, a height of the dummy patterns 70 may be substantially equal to a height of the wiring portions 23a and 23b. However, some of the dummy patterns 70 may be formed higher than the wiring portions 23a and 23b. That is, the height of the dummy patterns 70 from the first substrate 100 (see FIG. 1) may be substantially equal to the height of the gate lines 221a, 223a, 221b and 223b from the first substrate 100 (see FIG. 1). However, the height of some of the dummy patterns 70 from the first substrate 100 may be greater than the height of the gate lines 221a, 223a, 221b and 223b from the first substrate 100. However, this is merely an example, and the height of the dummy patterns 70 can vary as long as the dummy patterns 70 can compensate for a step difference in the process of forming an organic layer.

The dummy patterns 70 can be arranged in any way. For example, the dummy patterns 70 may be spaced at regular intervals. When necessary, the dummy patterns 70 may be concentrated in a certain area. Alternatively, the density of the dummy patterns 70 can be varied according to the distance to the gate driver IC 31 or the distance to the gate lines 221a and 221b disposed adjacent to the dummy area DU1.

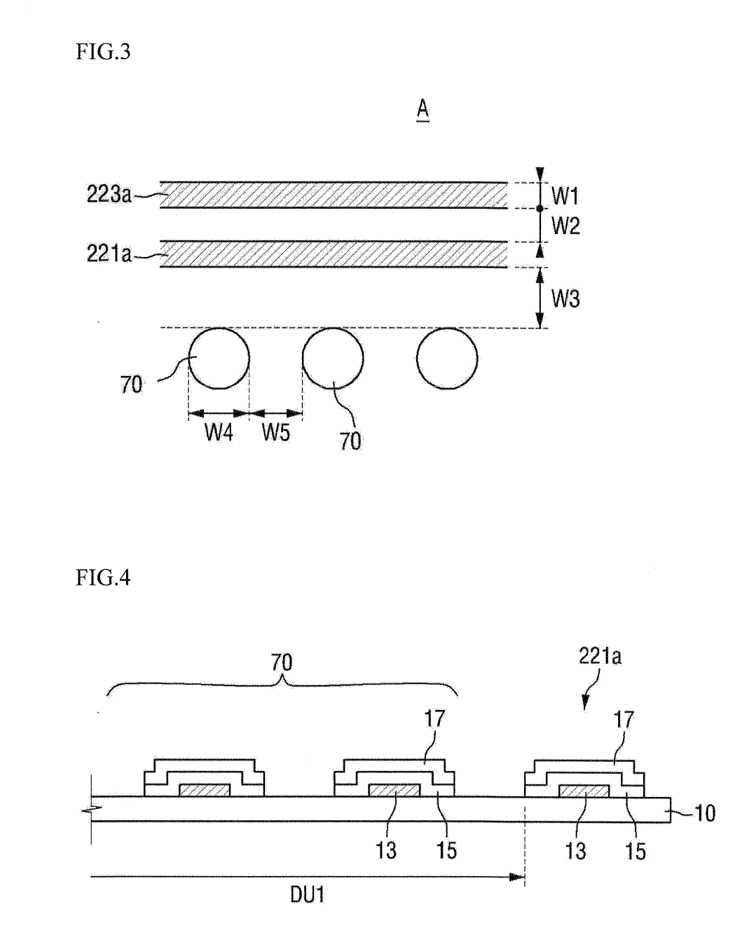

FIG. 3 is an enlarged view of a portion of the display device 1 shown in FIG. 2. More specifically, FIG. 3 is an enlarged view of a portion A of FIG. 2.

Referring to FIGS. 2 and 3, a ratio of a width W1 of each of the gate lines 221a and 223a which form the first wiring portion 23a to a gap W2 between the gate lines 221a and 223a may be in a range of 1:1 to 1:1.5. For example, if the width W1 of the gate line 223a may be 5 μm, the maximum gap W2 between the gate lines 221a and 223a may be formed in a range of 5 to 7.5 μm. If the maximum gap W2 between the gate lines 221a and 223a may be formed within a predetermined range of ratios to the width W1 of each of the gate lines 221a and 223a, the gate lines 221a and 223a themselves can compensate a step difference in the first wiring portion 23a (see FIG. 2). Therefore, an organic layer formed on the first wiring portion 23a (see FIG. 2) can have a uniform thickness.

A minimum value of a gap W3 between the gate line 221a (and the gate line 221b in FIG. 2) most adjacent to the dummy area DU1 (see FIG. 2) and the dummy patterns 70 may be 5 to 40 μm, so that the effect of the dummy patterns 70 on the gate line 221a (and the gate line 221b in FIG. 2) can be minimized while a step difference can be compensated for when an organic layer may be formed. However, this is merely an example, and the minimum value of the gap W3 can be varied within an appropriate range in view of the width of each gate line, the type of the material that forms the organic layer, etc.

A width W4 of each dummy pattern 70 may be, but is not limited to, 3 to 20 μm, and a gap W5 between the dummy patterns 70 may be, but is not limited to, 3 to 40 μm. That is, the width W4 of each dummy pattern 70 and the gap W5 between the dummy patterns 70 can also be varied within an appropriate range in view of the width of each gate line 221a or 223a, the type and etch rate of the material that forms the gate lines 221a and 223a or the dummy patterns 70, the type of the material that forms the organic layer, the efficiency of a process for forming the dummy patterns 70, etc.

The above description also applies to the second wiring portion 23b (see FIG. 2), and thus a description of the second wiring portion 23b will be omitted.

FIG. 4 is a cross-sectional view of the display device 1 of FIG. 2, taken along the line I1-I2.

Referring to FIGS. 2 through 4, the gate line 221a may be formed on a substrate 10 made of transparent glass or plastic. The gate line 221a may include a gate conductive layer 13 and a gate insulating layer 15 formed on the gate conductive layer 13. In addition, a passivation layer 17 may further be formed on the gate insulating layer 15.

The dummy patterns 70 may be formed in the dummy area DU1 of the fanout area FA (see FIG. 1). The dummy patterns 70 may have the same structure as the gate line 221a. That is, each of the dummy patterns 70 may include a gate conductive layer 13 formed on the substrate 10 and a gate insulating layer 15 formed on the gate conductive layer 13. Each of the dummy patterns 70 may further include a passivation layer 17 formed on the gate insulating layer 15.

The gate conductive layer 13 may be made of, but not limited to, metal with low resistivity, for example, aluminum (Al)-based metal such as aluminum or an aluminum alloy, silver (Ag)-based metal such as silver or a silver alloy, or copper (Cu)-based metal such as copper or a copper alloy.

The gate insulating layer 15 may be made of an organic insulating material or an inorganic insulating material.

The dummy patterns 70 and the gate line 221a may be formed simultaneously by the same process. For example, the gate conductive layer 13, the gate insulating layer 15, and the passivation layer 17 may be stacked sequentially on the substrate 10 and then patterned and etched together, thereby simultaneously forming the gate line 221a and the dummy patterns 70 as shown in FIG. 4. However, this is merely an example, and the dummy patterns 70 according to the present invention can be formed in various ways using all technologies that have been developed and commercialized or are realizable depending on future technological developments.

The dummy patterns 70 can minimize the occurrence of a step difference when an organic layer may be formed.

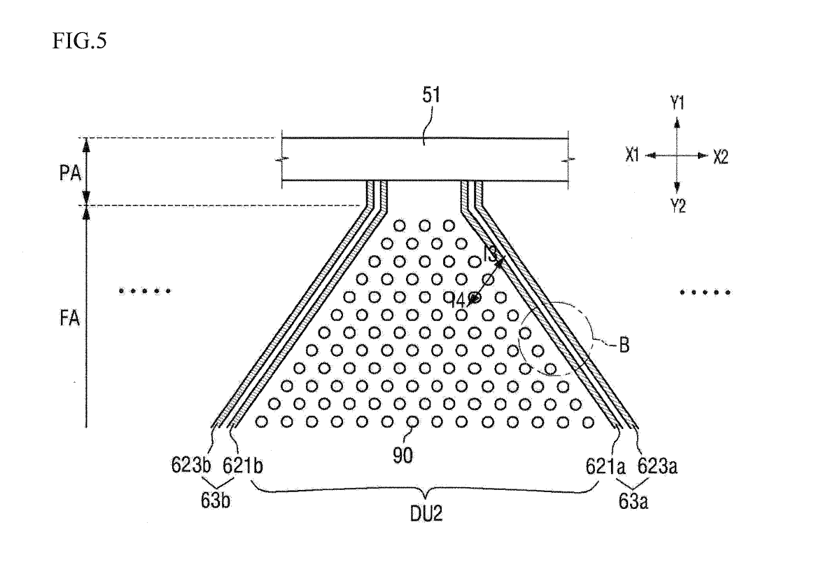

FIG. 5 is an enlarged view of a portion of the display device 1 shown in FIG. 1. More specifically, FIG. 5 is an enlarged view of the fanout area FA formed on the side of the data driver 50.

Referring to FIGS. 1 and 5, a plurality of data lines 621a, 623a, 621b and 623b may be electrically connected to the data driver IC 51 in the pad area PA by data pads (not shown). The data lines 621a, 623a, 621b and 623b may form wiring portions 63a and 63b which are, overall, trapezoidal.

The wiring portions 63a and 63b may include the third wiring portion 63a which has a negative slope with respect to the X1-X2 axis and consists of the data lines 621a and 623a extending in an X2-Y2 direction and the second wiring portion 63b which has a positive slope with respect to the X1-X2 axis and consists of the data lines 621b and 623b extending in an X1-Y2 direction. A dummy area DU2 may be formed between the third wiring portion 63a and the fourth wiring portion 63b.

A plurality of dummy patterns 90 may be formed in the dummy area DU2. The dummy patterns 90 may be separated from each other. An area of the fanout area FA in which the wiring portions 63a and 63b are not formed may be lower than the wiring portions 63a and 63b in which the data lines 621a, 623a, 621b and 623b are concentrated. Accordingly, when an organic layer may be formed by coating an organic material, it may be formed to have a non-uniform thickness, resulting in linear stains in an image. In the current embodiment, the dummy patterns 90 may be formed in the dummy area DU2 to compensate for a step difference between the wiring portions 63a and 63b and their surrounding area. When an organic layer may be formed, the dummy patterns 90 prevent an organic material from being concentrated in a certain area due to the step difference. Thus, the organic layer can be formed to a uniform height, minimizing stain defects in an image.

The dummy patterns 90 can have any planar shape. In FIG. 5, the planar shape of the dummy patterns 90 may be a circular shape. However, this is merely an example, and the dummy patterns 90 can have various planar shapes. For example, the planar shape of the dummy patterns 90 may be any one of a polygonal shape (such as a triangle, a quadrangle, a pentagon or a hexagon) and an oval shape or a combination of these shapes. In particular, if the dummy patterns 90 have a planar shape without corners, such as a circular shape or an oval shape, the effect of static electricity can additionally be minimized as in the case of the dummy patterns 70 (see FIG. 2) described above with reference to FIG. 2.

To compensate for a step difference, a height of the dummy patterns 90 may be substantially equal to a height of the wiring portions 63a and 63b. However, some of the dummy patterns 90 may be formed higher than the wiring portions 63a and 63b. That is, the height of the dummy patterns 90 from the first substrate 100 (see FIG. 1) may be substantially equal to the height of the data lines 621a, 623a, 621b and 623b from the first substrate 100 (see FIG. 1). However, the height of some of the dummy patterns 90 from the first substrate 100 may be greater than the height of the data lines 621a, 623a, 621b and 623b from the first substrate 100. However, this is merely an example, and the height of the dummy patterns 90 can vary as long as the dummy patterns 90 can compensate for a step difference in the process of forming an organic layer.

The dummy patterns 90 can be arranged in any way. For example, the dummy patterns 90 may be spaced at regular intervals. When necessary, the dummy patterns 90 may be concentrated in a certain area. Alternatively, the density of the dummy patterns 90 can be varied according to the distance to the data driver IC 51 or the distance to the data lines 621a and 621b disposed adjacent to the dummy area DU2.

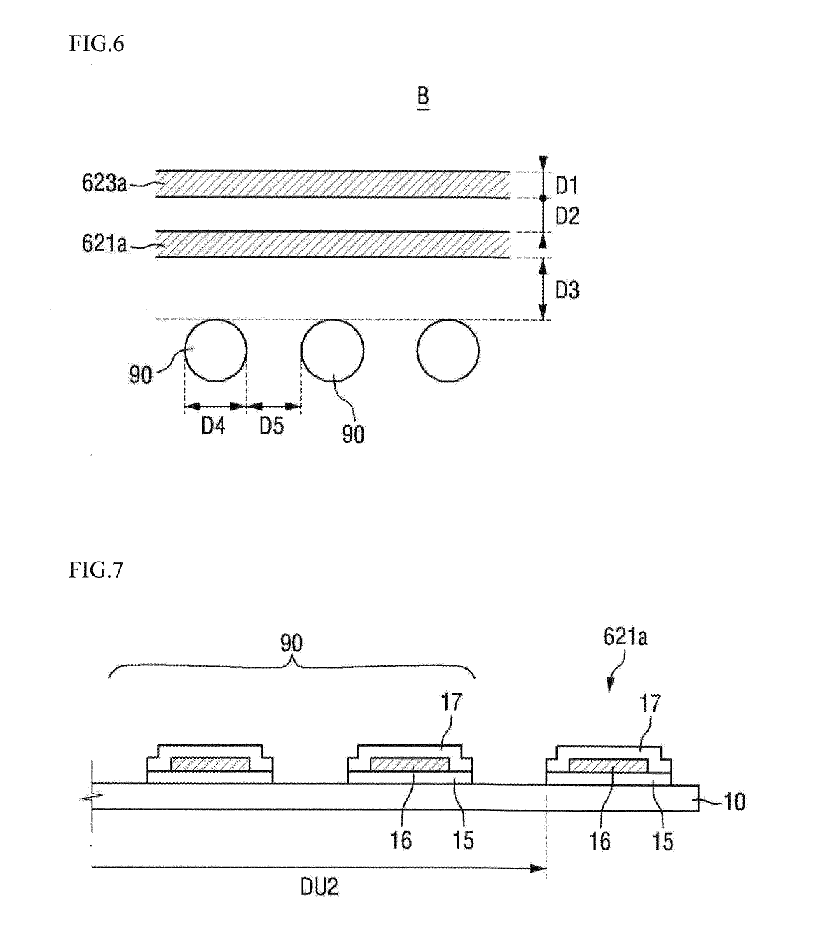

FIG. 6 is an enlarged view of a portion of the display device 1 shown in FIG. 5. More specifically, FIG. 6 is an enlarged view of a portion B of FIG. 5.

Referring to FIGS. 5 and 6, a ratio of a width D1 of each of the data lines 621a and 623a which form the third wiring portion 63a to a gap D2 between the data lines 621a and 623a may be in a range of 1:1 to 1:1.5. For example, if the width D1 of the data line 623a may be 5 μm, the maximum gap D2 between the data lines 621a and 623a may be formed in a range of 5 to 7.5 μm. If the maximum gap D2 between the data lines 621a and 623a may be formed within a predetermined range of ratios to the width D1 of each of the data lines 621a and 623a, the data lines 621a and 623a themselves can compensate a step difference in the third wiring portion 63a (see FIG. 5). Therefore, an organic layer formed on the third wiring portion 63a (see FIG. 5) can have a uniform thickness.

A minimum value of a gap W3 between the data line 621a (and the data line 621b in FIG. 5) most adjacent to the dummy area DU2 (see FIG. 5) and the dummy patterns 90 may be 5 to 40 μm, so that the effect of the dummy patterns 90 on the data line 621a (and the data line 621b in FIG. 5) can be minimized while a step difference can be compensated for when an organic layer may be formed. However, this is merely an example, and the minimum value of the gap D3 can be varied within an appropriate range in view of the width of each data line, the type and etch rate of the material that forms the data lines or the dummy patterns 90, the type of the material that forms the organic layer, etc.

A width D4 of each dummy pattern 90 may be, but is not limited to, 3 to 20 μm, and a gap D5 between the dummy patterns 90 may be, but is not limited to, 3 to 40 μm. That is, the width D4 of each dummy pattern 90 and the gap D5 between the dummy patterns 90 can also be varied within an appropriate range in view of the width of each data line, the type and etch rate of the material that forms the data lines or the dummy patterns 90, the type of the material that forms the organic layer, the efficiency of a process for forming the dummy patterns 90, etc.

In addition, the width D4 of the dummy patterns 90, the gap D5 between the dummy patterns 90, and the minimum value of the gap D3 between the data line 621a and the dummy patterns 90 may be equal to or different from the width W4 (see FIG. 3) of the dummy patterns 70 (see FIG. 3), the gap W4 (see FIG. 3) between the dummy patterns 70 (see FIG. 3), and the minimum value of the gap W3 between the gate line 221a (see FIG. 3) and the dummy patterns 70 (see FIG. 3).

The above description also applies to the fourth wiring portion 63b (see FIG. 5), and thus a description of the fourth wiring portion 63b will be omitted.

FIG. 7 is a cross-sectional view of the display device 1 of FIG. 5, taken along the line I3-I4.

Referring to FIGS. 5 through 7, the data line 621a may be formed on a substrate 10 made of transparent glass or plastic. The data line 621a may include a gate insulating layer 15 and a data conductive layer 16 formed on the gate insulating layer 15. In addition, a passivation layer 17 may further be formed on the data conductive layer 16.

The dummy patterns 90 may be formed in the dummy area DU2 of the fanout area FA (see FIG. 1). The dummy patterns 90 may have the same structure as the data line 621a. That is, each of the dummy patterns 90 may include a gate insulating layer 15 formed on the substrate 10 and a data conductive layer 16 formed on the gate insulating layer 15. Each of the dummy patterns 90 may further include a passivation layer 17 formed on the data conductive layer 16.

The gate insulating layer 15 may be made of an organic insulating material or an inorganic insulating material.

The data conductive layer 16 may be made of refractory metal such as molybdenum, chrome, tantalum and titanium. In addition, the data conductive layer 16 may have a multilayer structure composed of a refractory metal layer (not shown) and a conductive layer (not shown) with low resistivity. However, this is merely an example, and the present invention is not limited to this example.

The dummy patterns 90 and the data line 621a may be formed simultaneously by the same process. For example, the gate insulating layer 15, the data conductive layer 16 and the passivation layer 17 may be stacked sequentially on the substrate 10 and then patterned and etched together, thereby simultaneously forming the data line 621a and the dummy patterns 90 as shown in FIG. 7. However, this is merely an example, and the dummy patterns 90 according to the present invention can be formed in various ways using all technologies that have been developed and commercialized or are realizable depending on future technological developments.

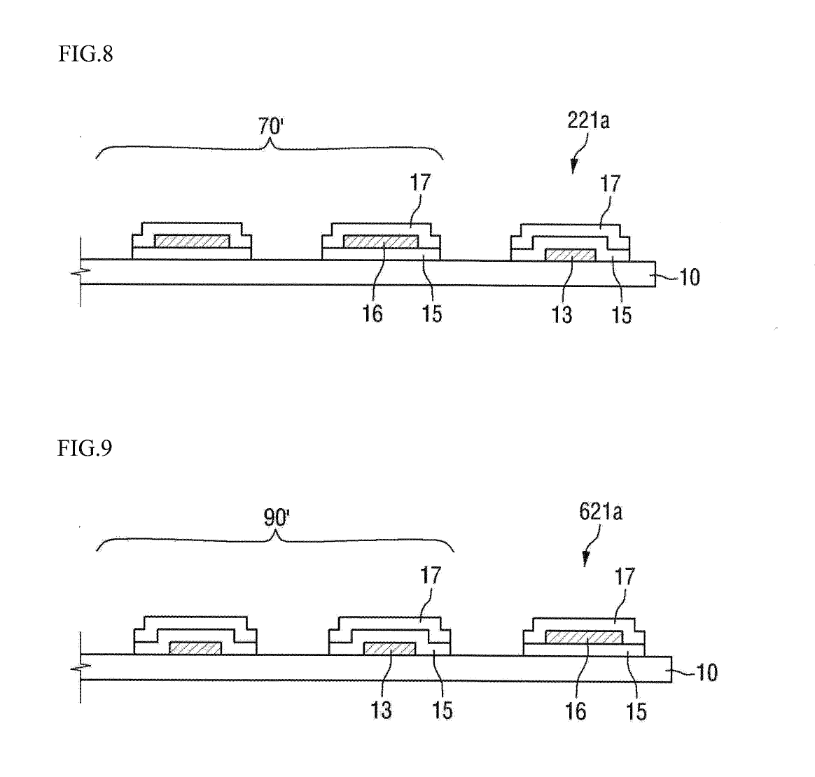

FIG. 8 is a cross-sectional view of a modified embodiment of the display device 1 of FIG. 2, taken along the line I1-I2. More specifically, FIG. 8 shows another structure of dummy patterns formed on the side of the gate driver 30 (see FIG. 2).

Referring to FIG. 8, dummy patterns 70′ of FIG. 8 may have the same structure as the dummy patterns 90 (see FIG. 7) described above with reference to FIG. 7. That is, each of the dummy patterns 70′ according to the current embodiment may include a gate insulating layer 15 formed on a substrate 10 and a data conductive layer 16 formed on the gate insulating layer 15. Each of the dummy patterns 70′ may further include a passivation layer 17 formed on the data conductive layer 16. The height and width of the dummy patterns 70′ and the gap between the dummy patterns 70′ are equal to those of the dummy patterns 70 described above with reference to FIGS. 2 and 3. In addition, the material that forms the dummy patterns 70′ and a method of forming the dummy patterns 70′ are identical to those for the dummy patterns 90 described above with reference to FIG. 7. Therefore, a repetitive description will be omitted.

FIG. 9 is a cross-sectional view of a modified embodiment of the display device 1 of FIG. 5, taken along the line I3-I4. More specifically, FIG. 9 shows another structure of dummy patterns formed on the side of the data driver 50 (see FIG. 5).

Referring to FIG. 9, dummy patterns 90′ of FIG. 9 may have the same structure as the dummy patterns 70 (see FIG. 4) described above with reference to FIG. 4. That is, each of the dummy patterns 90′ according to the current embodiment may include a gate conductive layer 13 formed on a substrate 10 and a gate insulating layer 15 formed on the gate conductive layer 13. Each of the dummy patterns 90′ may further include a passivation layer 17 formed on the gate insulating layer 15. The height and width of the dummy patterns 90′ and the gap between the dummy patterns 90′ are equal to those of the dummy patterns 90 described above with reference to FIGS. 5 and 6. In addition, the material that forms the dummy patterns 90′ and a method of forming the dummy patterns 90′ are identical to those for the dummy patterns 70 described above with reference to FIG. 4. Therefore, a repetitive description will be omitted.

Embodiments of the present invention provide at least one of the following advantages.

Stain defects due to an organic layer can be minimized by minimizing a step difference of the organic layer.

A display device which can provide a uniform image by minimizing stain defects can be provided.

However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A display device, comprising:
a first substrate comprising a display area and a fanout area;
a plurality of pixels formed in the display area;
a plurality of signal lines connected to the pixels in the display area and forming a plurality of wiring portions in the fanout area; and
a plurality of dummy patterns formed in a dummy area between the wiring portions.

2. The display device of claim 1, wherein a height of the dummy patterns from the first substrate is equal to or greater than a height of the wiring portions from the first substrate.

3. The display device of claim 1, wherein the dummy patterns are spaced at regular intervals.

4. The display device of claim 1, wherein a gap between the dummy patterns is 3 μm to 40 μm.

5. The display device of claim 1, wherein a planar shape of the dummy patterns is one of a triangle, a quadrangle, a polygon, a circle, and an oval.

6. The display device of claim 1, wherein a width of each of the dummy patterns is 3 μm to 20 μm.

7. The display device of claim 1, wherein a ratio of a width of the signal lines to a maximum value of a gap between the signal lines in the wiring portions is 1:1 to 1:5.

8. The display device of claim 1, wherein a minimum value of a gap between the signal lines and the dummy patterns is 5 μm to 40 μm.

9. The display device of claim 1, wherein the signal lines are gate lines and data lines.

10. The display device of claim 9, wherein at least one of the dummy patterns comprises:
a gate conductive layer formed on a substrate;
a gate insulating layer formed on the gate conductive layer; and
a passivation layer formed on the gate insulating layer.

11. The display device of claim 9, wherein at least one of the dummy patterns comprises:
a gate insulating layer formed on the substrate;
a data conductive layer formed on the gate insulating layer; and
a passivation layer formed on the data conductive layer.

12. The display device of claim 1, further comprising:
a second substrate facing the first substrate; and
a liquid crystal layer interposed between the first substrate and the second substrate.

13. The display device of claim 12, wherein the second substrate comprises a common electrode formed on a surface thereof which faces the first substrate.

14. A display device, comprising:
a display area in which a plurality of signal lines intersect each other;
a pad area in which a plurality of pads delivering signals received from an external source to the signal lines and connected to the signal lines are disposed;
a fanout area which is formed between the pad area and the display area and in which a plurality of wiring portions connecting the pads and the signal lines are formed; and
a plurality of dummy patterns which are formed in a dummy area between the wiring portions.

15. The display device of claim 14, wherein a step difference of the dummy patterns is equal to or greater than that of the wiring portions.

16. The display device of claim 14, wherein the dummy patterns are spaced at regular intervals.

17. The display device of claim 14, wherein a gap between the dummy patterns is 3 to 40 μm.

18. The display device of claim 14, wherein a planar shape of the dummy patterns is one of a triangle, a quadrangle, a polygon, a circle, and an oval.

19. The display device of claim 14, wherein a width of each of the dummy patterns is 3 to 20 μm.

20. The display device of claim 14, wherein a ratio of a width of the signal lines to a maximum value of a gap between the signal lines in the wiring portions is 1:1 to 1:5.

21. The display device of claim 14, wherein a minimum value of a gap between the signal lines and the dummy patterns is 5 μm to 40 μm.

22. The display device of claim 14, wherein the signal lines are gate lines and data lines.

23. The display device of claim 22, wherein at least one of the dummy patterns comprises:
a gate conductive layer formed on a substrate;
a gate insulating layer formed on the gate conductive layer; and
a passivation layer formed on the gate insulating layer.

24. The display device of claim 22, wherein at least one of the dummy patterns comprises:
a gate insulating layer formed on the substrate;
a data conductive layer formed on the gate insulating layer; and
a passivation layer formed on the data conductive layer.

25. A display device, comprising:
a first substrate;
a second substrate facing the first substrate; and
a liquid crystal layer interposed between the first substrate and the second substrate,
wherein the first substrate comprises:
a display area in which a plurality of signal lines intersect each other;
a pad area in which a plurality of pads delivering signals received from an external source to the signal lines and connected to the signal lines are disposed;
a fanout area which is formed between the pad area and the display area and in which a plurality of wiring portions connecting the pads and the signal lines are formed; and
a plurality of dummy patterns which are formed in a dummy area between the wiring portions.

26. The display device of claim 25, wherein the second substrate comprises a common electrode formed on a surface thereof which faces the first substrate.
